(19) United States
(12) Patent Application Publication
(10) Pub. No.: US 2014/0356024 A1
(43) Pub. Date: Dec. 4, 2014

(54) IMAGE FORMING APPARATUS

(71) Applicant: KYOCERA Document Solutions Inc., Osaka (JP)

(72) Inventor: Yusuke TAKANO, Osaka (JP)

(73) Assignee: KYOCERA DOCUMENT SOLUTIONS INC., Osaka (JP)

(21) Appl. No.: 14/287,509

(22) Filed: May 27, 2014

(30) Foreign Application Priority Data
May 30, 2013 (JP) 2013-114631

(51) Int. Cl. G03G 15/00; G03G 21/16

(52) U.S. Cl. CPC G03G 21/1633; G03G 21/1676; G03G 21/1695
USPC 399/110; 399/111

(57) ABSTRACT

An image forming apparatus includes a cover main body, a turning axis and a sub-cover. The cover main body constitutes at least a part of a vertical wall face of an image forming apparatus main body and constitutes at least a part of a top face wall of the image forming apparatus main body. The turning axis supports turnably the cover main body around a turning fulcrum near a lower end at the vertical wall face side. The sub-cover is configured to be openable/closable at least a part of the top face wall in the cover main body. The cover main body is turned so as to open an area from at least a part of the vertical wall face of the image forming apparatus main body to at least a part of the top face wall of the image forming apparatus main body.

### INCORPORATION BY REFERENCE

This application is based on and claims the benefit of priority from Japanese Patent application No. 2013-114631 filed on May 30, 2013, the entire contents of which are incorporated herein by reference.

### BACKGROUND

The present disclosure relates to an image forming apparatus using electrographic process.

In an image forming apparatus using electrographic process, inside an image forming apparatus main body, for example, a process unit forming an image on the basis of image data, a replacable developer cartridge unit filling a developer, such as a toner, or others are arranged.

The process unit is fixed at a predetermined position inside the image forming apparatus main body by screws or the like because of having various driving system or the like used for conveyance of a recording sheet and others. Therefore, for example, in the image forming apparatus in a type of ejecting the recording sheet from a back face side to a front face side in the image forming apparatus main body, particularly as a small image forming apparatus, a part of a side face wall of the image forming apparatus main body is opened, and thereby, approach for jam treatment and others is enabled.

However, recently, although the image forming apparatus main body needs downsizing and others, if the side face wall of the image forming apparatus main body is opened in order to enable the jam treatment and others, since a large installation space must be secured as result, a problem of losing significance of the downsizing is caused.

Therefore, in order to enable the replacement of the developer cartridge unit and the approach to the process unit, it is considered that the front face wall side of the image forming apparatus main body is configured to be openable.

Then, since a conveyance direction of the recording sheet is set from the back face side to the front face side in the image forming apparatus main body, particularly the process unit may be configured to be detachable or drawable from the image forming apparatus main body.

Concretely, a first rail part fixed inside the image forming apparatus main body and a second rail part slidably connected and supported to the first rail part are arranged so that the process unit is greatly drawn from the inside of the image forming apparatus main body.

On the other hand, for example, there is an increasing demand of making a multifunction peripheral by optionally attaching an automatic document feeder (hereinafter, called as an “ADF”) to a dedicated printer as the image forming apparatus main body and providing the ADF with image reading function.

However, if the ADF is optionally installed to the small dedicated printer as mentioned above, the ADF device, an operational panel and others are arranged above an ejected tray as a top face of the image forming apparatus main body.

Then, in order to draw the developer cartridge unit or the process unit from the image forming apparatus main body, it is necessary to arrange a front cover constituting at least a part of the front face wall of the image forming apparatus main body and constituting at least a part of a top face wall of the image forming apparatus main body. In addition, it is necessary to configure the front cover so as to turn to the front face side of the image forming apparatus main body around a turning axis, and accordingly, to open a wide area from at least the part of the front face wall to at least the part of the top face wall in the image forming apparatus main body.

However, when the wide area from the front face wall to the top face wall in the image forming apparatus main body is opened by the front cover, the ADF located above the top face wall becomes obstruction, and accordingly, there is caused a new problem of restricting a size of the front cover, i.e., an opening area, and restricting a turning direction of the front cover.

Thus, if the opening area is restricted, a relative size of the opening area to the developer cartridge unit and process unit becomes insufficient. Therefore, there are caused problems of difficulty of drawing these from the image forming apparatus main body and of narrowing a working space for the approach for the jam treatment and a working space for a unit drawing work.

Incidentally, if the AFD is configured similarly to the front cover or to be openable in a reverse direction, the structure supporting the ADF in the image forming apparatus main body is complicated, and accordingly, product costs of the image forming apparatus main body are increased.

### SUMMARY

An image forming apparatus includes a cover main body, a turning axis and a sub-cover. The cover main body constitutes at least a part of a vertical wall face of an image forming apparatus main body and constitutes at least a part of a top face wall of the image forming apparatus main body. The turning axis supports turnably the cover main body around a turning fulcrum near a lower end at the vertical wall face side. The sub-cover is configured to be openable/closable at least apart of the top face wall in the cover main body. The cover main body is turned so as to open an area from at least a part of the vertical wall face of the image forming apparatus main body to at least a part of the top face wall of the image forming apparatus main body.

The above and other objects, features, and advantages of the present disclosure will become more apparent from the following description when taken in conjunction with the accompanying drawings in which a preferred embodiment of the present disclosure is shown by way of illustrative example.

### BRIEF DESCRIPTION OF THE DRAWINGS

FIG. 1 is a perspective view showing an image forming apparatus according to an embodiment of the present disclosure.

FIG. 2 is a side view showing the image forming apparatus before a front cover is opened according to the embodiment of the present disclosure.

FIG. 3 is a perspective view showing the front cover applied to the image forming apparatus according to the embodiment of the present disclosure.

FIG. 4 is a front perspective view showing the front cover, in a situation where a sub-cover is opened, applied to the image forming apparatus according to the embodiment of the present disclosure.

FIG. 5 is a back (bottom) perspective view showing the front cover, in the situation where the sub-cover is opened, applied to the image forming apparatus according to the embodiment of the present disclosure.

FIG. 6 is a perspective view showing the image forming apparatus, in a situation where the front cover is opened, according to the embodiment of the present disclosure.

FIG. 7 is a side view showing the image forming apparatus, in the situation where the front cover is opened, according to the embodiment of the present disclosure.

FIG. 8 is a perspective view showing the image forming apparatus, in the situation where the sub-cover is opened, according to the embodiment of the present disclosure.

FIG. 9 is a side view showing the image forming apparatus, in the situation where the sub-cover is opened, according to the embodiment of the present disclosure.

### DETAILED DESCRIPTION

In the following, an image forming apparatus according to an embodiment of the present disclosure will be described with reference to the drawings. The embodiment described below is a preferable concrete example of the image forming apparatus of the present disclosure, although there may be a case of providing various limitations which are technically preferable, the technical scope of the present disclosure is not limited to these aspects unless otherwise there exists a descriptive matter to limit the present disclosure in particular. Further, the constituent elements in the below-described embodiment of the present disclosure can be appropriately replaced with the existing constituent elements or the like, and diversified variations including a combination with any other existing constituent elements are possible. Therefore, the contents of the disclosure set forth in the claims are not limited by the following description of the embodiment of the present disclosure.

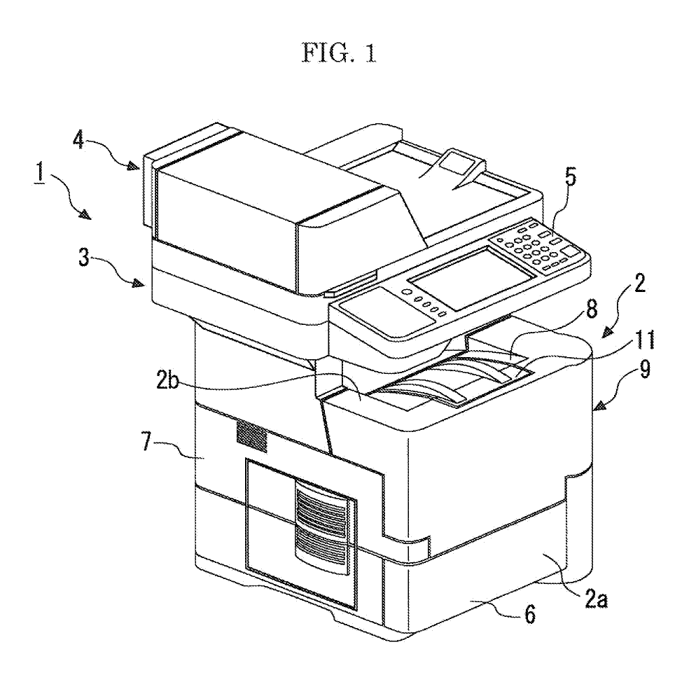

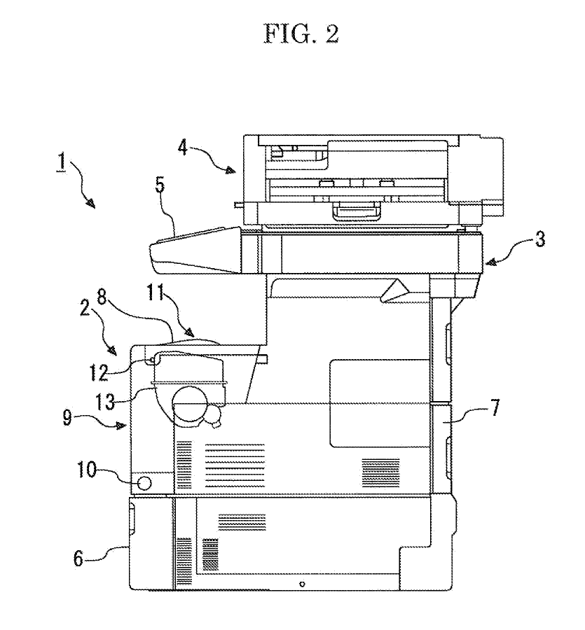

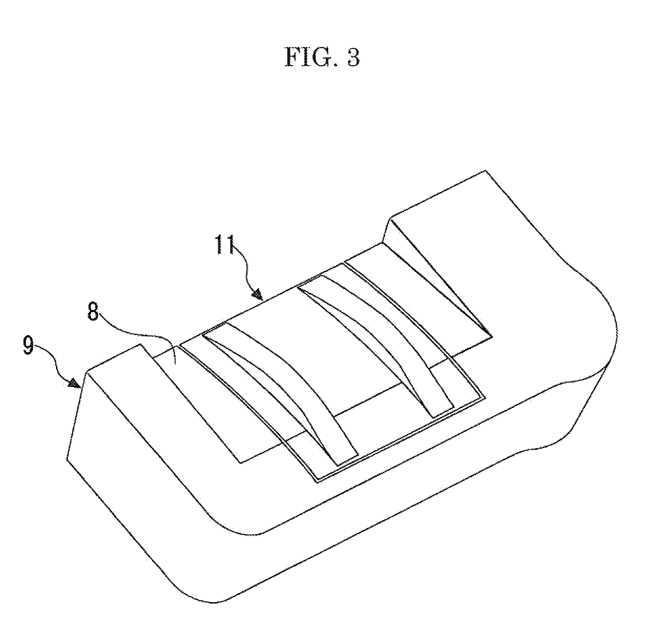

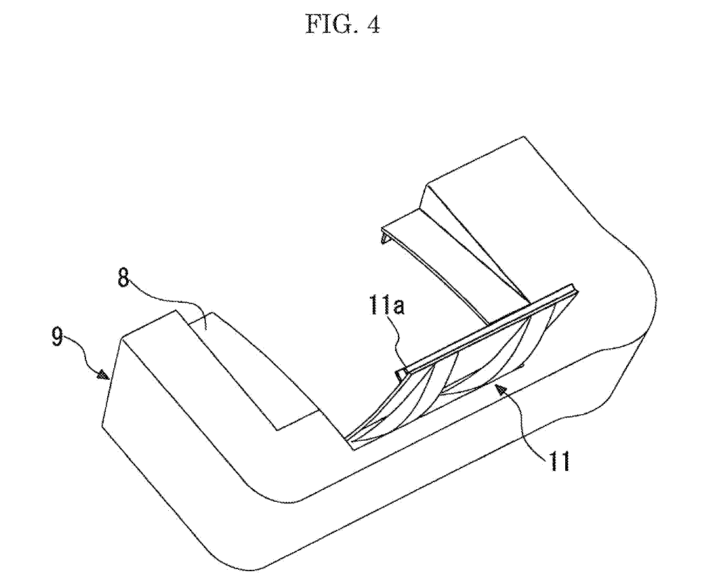

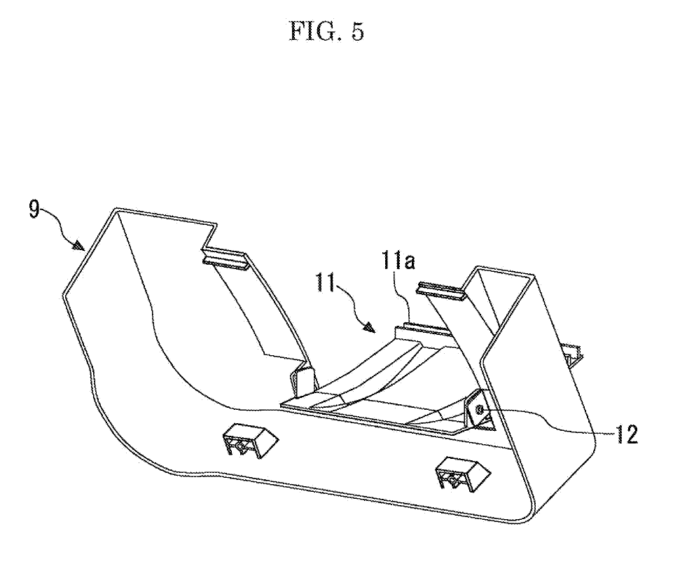

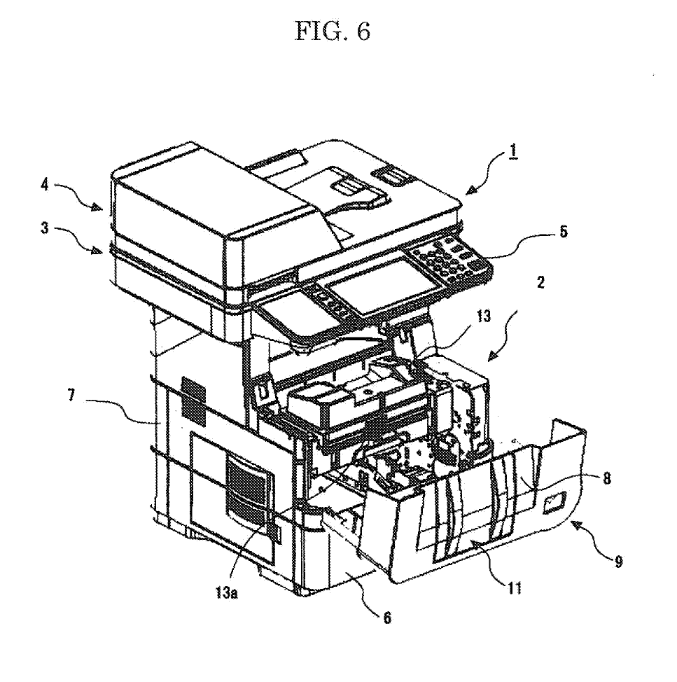

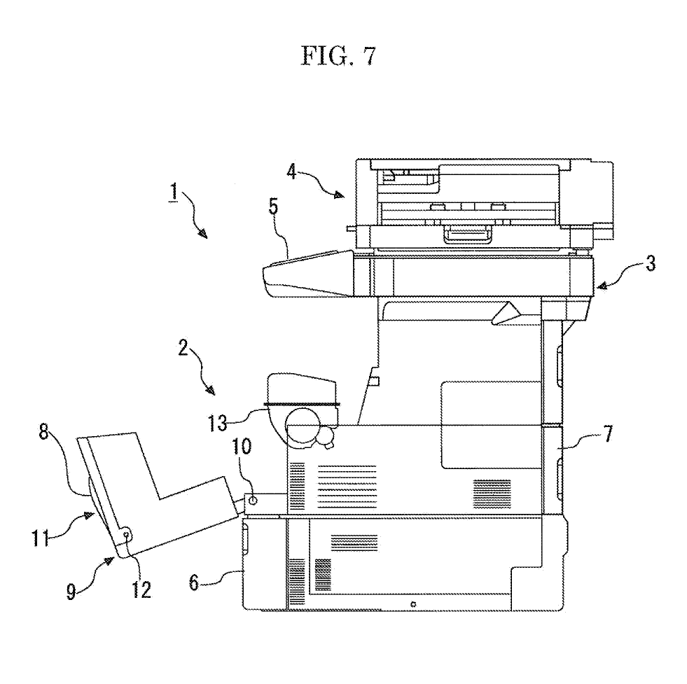

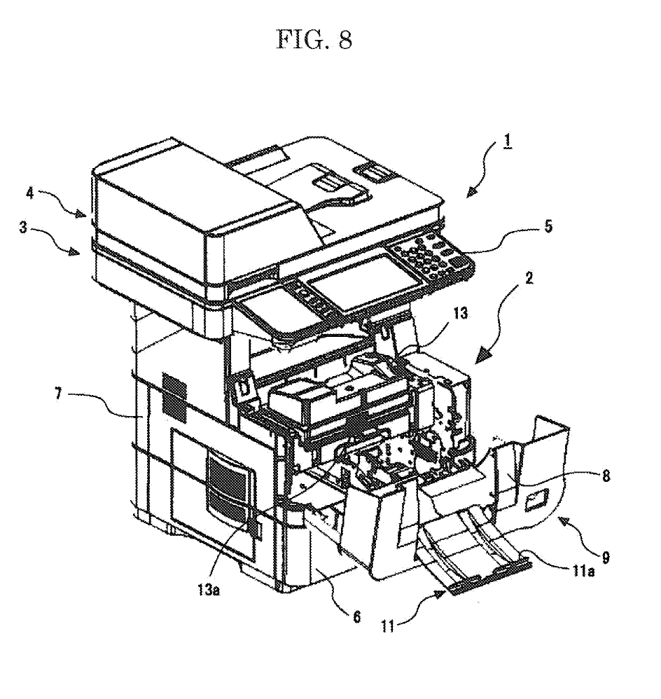

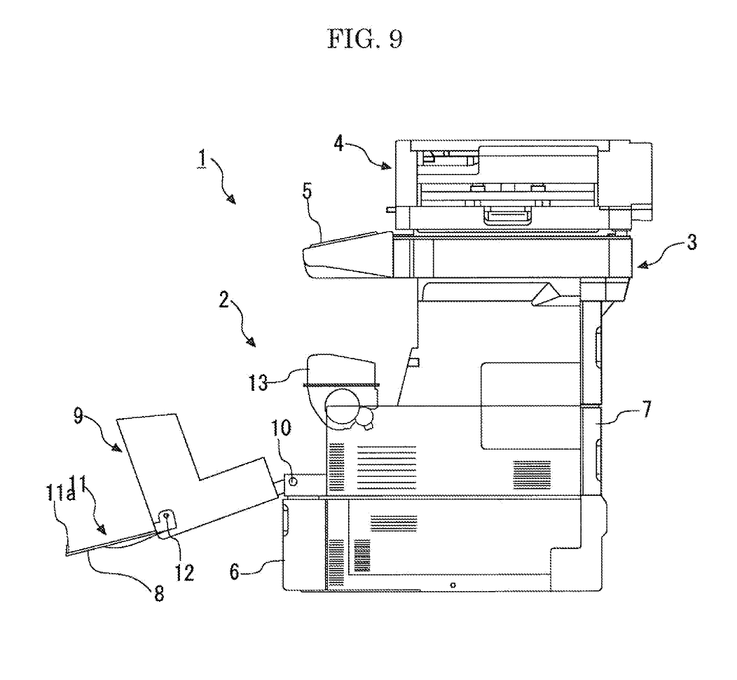

FIG. 1 is a perspective view of the image forming apparatus according to the embodiment of the present disclosure. FIG. 2 is a side view of the image forming apparatus before a front cover is opened according to the embodiment of the present disclosure. FIG. 3 is a perspective view of the front cover applied to the image forming apparatus according to the embodiment of the present disclosure. FIG. 4 is a front perspective view of the front cover, in a situation where a sub-cover is opened, applied to the image forming apparatus according to the embodiment of the present disclosure. FIG. 5 is a back (bottom) perspective view of the front cover, in the situation where the sub-cover is opened, applied to the image forming apparatus according to the embodiment of the present disclosure. FIG. 6 is a perspective view of the image forming apparatus, in a situation where the front cover is opened, according to the embodiment of the present disclosure. FIG. 7 is a side view of the image forming apparatus, in the situation where the front cover is opened, according to the embodiment of the present disclosure. FIG. 8 is a perspective view of the image forming apparatus, in the situation where the sub-cover is opened, according to the embodiment of the present disclosure. FIG. 9 is a side view of the image forming apparatus, in the situation where the sub-cover is opened, according to the embodiment of the present disclosure.

In FIGS. 1 and 2, the image forming apparatus 1 includes a printer main body 2 as an image forming apparatus main body, an image reading device 3 arranged above the printer main body 2 and an automatic document feeder 4 (ADF) arranged and piled above the image reading device 3.

The image reading device 3 and automatic document feeder 4 are optionally arranged attachably to/detachably from the printer main body 2. in a case where the image forming apparatus is a multifunction peripheral, the image reading device 3 and automatic document feeder 4 may be fixed as standard devices.

Inside the image reading device 3, an optical reading system reading an image of a document set on the automatic document feeder 4 is arranged. The detail description of the system is omitted. The image reading device 3 may be configured, for example, so as to include a platen glass and so that the automatic document feeder 4 is openably attached to the image reading device 3. In front of the image reading device 3, an operational panel 5 used for performing an image reading operation of the document is arranged. For example, the operational panel 5 is arranged above a top face wall of the printer main body 2 and protruded so as to cover at least a part of the top face wall.

The automatic document feeder 4 includes a structure allowing setting of a plurality of the documents, feeding the document to the image reading device 3 from the top and ejecting the document after the image is read by the image reading device 3. The detail description of the structure is omitted. The automatic document feeder 4 may include, for example, a second image reading device reading an image of a back face of the document separately from the image reading device 3.

In a lower step of the printer main body 2, a drawer-type sheet feeding cartridge 6 storable recording sheets (not shown) is installed. The sheet feeding cartridge 6 is configured to be drawable to a front face side of the printer main body 2. In an upper step of the printer main body 2, an apparatus main body 7 is provided, inside which a process unit, a developer cartridge unit and others are arranged. The process unit has a recording sheet conveying path for an image forming process. The developer cartridge unit replenishes the process unit with a developer, such as a toner. In at least a part of a top face wall of the printer main body 2, a sheet ejected tray 8 is formed, on which the recording sheets after the image forming process are accumulated.

The apparatus main body 7 includes a front cover 9 as a cover main body constituting a part of a front face of the printer main body 2 and constituting apart of the sheet ejected tray 8. The apparatus main body 7 includes a turning axis 10 used for turning the front cover 9 to the front face side of the printer main body 2. Accordingly, when the front cover 9 is turned to the front face side of the printer main body 2, an area from at least a part of a front face wall 2a of the printer main body 2 to at least a part of the top face wall 2b of the printer main body 2 is opened. Moreover, the front cover 9 includes a sub-cover 11 openable/closable at least a part of the sheet ejected tray 8.

Therefore, since the image forming apparatus 1 of the embodiment can open the front cover 9, and furthermore, open the sub-cover 11, even if an opening area of the printer main body 2 is restricted, it is possible to draw various units in the printer main body 2. In addition, it is possible to easily secure a working space for approach for jam treatment and a working space for a unit drawing work. Moreover, since the part of the sheet ejected tray 8 is constituted by the sub-cover 11, it is possible to easily carry out working approach the inside of the printer main body 2 by opening the sub-cover 11.

In the following, concrete structure of the front cover 9 and sub-cover 11 in the image forming apparatus 1 of the embodiment will be described with reference to FIGS. 3 to 5. In FIGS. 3 to 5, the front cover 9 at the upper side of the printer main body 2 is shown.

The sub-cover 11 includes a turning axis 12 turning as a turning fulcrum arranged at a vertical wall face side of the image forming apparatus 1. Thereby, the sub-cover 11 opens at least a part of the sheet ejected tray 8 to the front face side of the printer main body 2 similarly to the front cover 9. At this time, a free end part at the opposite side to the turning axis 12 and other parts in the sub-cover 11 are not locked to the front cover 9.

Therefore, since the front cover 9 and sub-cover 11 are turned in the same direction, when the front cover 9 is opened, the sub-cover 11 can turned around the turning axis 12 as a turning fulcrum by its empty weight and at least the part of the sheet ejected tray 8 can be opened.

Thereby, since the front cover 9 is tuned, and simultaneously, the sub-cover 11 is tuned by its empty weight, it is possible to carry out opening work of two covers 9 and 11 by a series of work.

In the sub-cover 11, in an inner face near a free end at an opposite side to the turning axis 12, a lib 11a is formed. This lib 11a can secure strength at the free end side of the sub-cover 11 when the recording sheets are accumulated on the ejected tray 8. Since the lib 11a functions as a weight, it is possible to easily turn the sub-cover 11 by its empty weight.

On the other hand, inside the printer main body 2, internal units drawable in a situation where the front cover 9 is opened are installed. As the internal units, concretely, there are the developer cartridge unit 13 and process unit (not shown). For example, the process unit is arranged near the top face wall at a back face side in the printer main body 2 to convey the recording sheet to the back face side and to perform the image forming process. For example, the developer cartridge unit is arranged near the top face wall at the front face side in the printer main body 2 to replenish the process unit with the developer.

The developer cartridge unit 13 contains a black (K) toner as a replenishment developer, in a case where the image forming apparatus 1 works as a monochrome printing device. The replenishment developer contained in the developer cartridge unit 13 is supplied, for example, to the process unit. The process unit constitutes an image forming process part conveying the recording sheet and performing the image forming process on the recording sheet on the basis of image data outputted from a personal computer (not shown) or the like, image data read by the image reading device 3 or other data.

In the process unit, an image carrier, such as a photosensitive drum, an electrographic exposure device and others are applied. The image carrier is used for performing the image forming process as mentioned above. The exposure device forms a latent image on the image carrier on the basis of the image data so that the image carrier carries the toner.

In addition, in the process unit, a conveying path is applied. In the conveying path, first, the recording sheet stored in the sheet feeding cartridge 6 is fed from the front face side of the printer main body 2. Subsequently, the recording sheet is conveyed to a back face side of the printer main body 2, and then, the image forming process is performed. Furthermore, the recording sheet is conveyed from the back face side to the front face side in the printer main body 2, and then, ejected to the sheet ejected tray 8. Then, takeout the recording sheet from the front face side in the printer main body 2 is allowed.

Since a conveying direction of the recording sheet in the process unit is set along forward and backward directions of the printer main body 2, if the jam of the recording sheet is occurred in the middle of the image forming process part, the approach for the jam treatment must carried out from the front face, the top face or the side face of the printer main body 2 in accordance with the size of the recording sheet and the position of the jam.

The developer cartridge unit 13 is configured to be replacable to the printer main body 2 and drawable from the front face side of the printer main body 2 separately from or unitedly with the process unit. As a mechanism drawing the developer cartridge unit 13 and the process unit, for example, a structure making the process unit drawable unitedly with the developer cartridge unit 13 along a rail arranged at the side face side of the printer main body 2 is applied. The detail description of the mechanism is omitted.

Therefore, in a case where the internal units are configured to be drawable, for example, when the developer cartridge unit 13 is replaced or when the process unit is drawn for the approach from the side face side of the printer main body 2 for the jam treatment, the sub-cover 11 can be opened in advance by opening the front cover 9 when the internal units are drawn, and accordingly, it is possible to easily draw the internal units without the obstruction of the sub-cover 11. That is, working approach to a unit side face side of the process unit is allowed.

In the above-mentioned configuration, for example, if the jam of the recording sheet is occurred during the image forming process, as shown in FIGS. 6 and 7, the front cover is turned around the turning axis 10 as a turning fulcrum to open the area from the part of the front face side to the part of the sheet ejected tray 8 at the top face side in the printer main body 2.

Accordingly, since the turning axis 10 is positioned near the lower side in the front face side of the printer main body 2, it is possible to open the front cover 9 in a wide area to 90 degrees or more.

For example, in order to draw the process unit (arranged in an area at the backward side from the lower side of the developer cartridge unit 13), the developer cartridge unit 13 is often provided with a handle part 13a grasped by a worker. In such a case, if the free end side of the sub-cover 11 is fixed, the fixing may obstruct grasping of the handle part 13a.

However, in the embodiment, as shown in FIGS. 8 and 9, when the front cover 9 is opened, since the sub-cover 11 is turned around the turning axis 12 as the turning fulcrum and the part of the sheet ejected tray 8 is further opened, it is possible to sufficiently secure the working space between the internal units and front cover 9 by opening the top face of the front cover 9 and to easily draw the developer cartridge unit 13 as the internal unit unitedly with the process unit.

Thus, in accordance with the present disclosure, the image forming apparatus 1 includes a front cover 9 and turning axis 10. The front cover 9 constitutes at least a part of a vertical wall face of the printer main body 2 and constitutes at least a part of the sheet ejected tray 8 at a top face wall of the printer main body 2. The turning axis 10 supports turnably the front cover 9 around a turning fulcrum near a lower end at the vertical wall face side. By turning the front cover 9, an area from at least a part of the vertical wall face of the printer main body 2 to at least apart of the sheet ejected tray 8 of the printer main body 2 is opened. Moreover, the image forming apparatus 1 includes the sub-cover 11 openable/closable at least a part of the sheet ejected tray 8 in the front cover 9. Accordingly, the front cover 9 can be opened, and furthermore, the sub-cover 11 can be opened. Therefore, even if an opening area of the printer main body 2 is restricted, it is possible to draw various internal units in the printer main body 2. In addition, it is possible to easily secure a working space for approach for jam treatment and a working space for a unit drawing work.

What is claimed is:

1. An image forming apparatus comprising:
a cover main body constituting at least a part of a vertical wall face of an image forming apparatus main body and constituting at least a part of a top face wall of the image forming apparatus main body;
a turning axis supporting turnably the cover main body around a turning fulcrum near a lower end at the vertical wall face side; and
a sub-cover configured to be openable/closable at least a part of the top face wall in the cover main body,
wherein the cover main body is turned so as to open an area from at least a part of the vertical wall face of the image forming apparatus main body to at least a part of the top face wall of the image forming apparatus main body.

2. The image forming apparatus according to claim 1, wherein the sub-cover includes a turning axis turning as a turning fulcrum arranged at a vertical wall face side of the image forming apparatus, and
the sub-cover opens at least a part of the top face wall by an empty weight of the sub-cover when the cover main body is opened.

3. The image forming apparatus according to claim 1, wherein the sub-cover includes a lib formed in an inner face near a free end.

4. The image forming apparatus according to claim 1, further comprising:
a sheet ejected tray arranged in the top face wall of the image forming apparatus main body.

5. The image forming apparatus according to claim 1, further comprising:
an internal unit drawably arranged inside the image forming apparatus main body, in a situation where the cover main body is opened.

6. The image forming apparatus according to claim 5, further comprising:
an operational panel arranged above the top face wall of the image forming apparatus main body and protruded so as to cover at least the part of the top face wall,
wherein a recording sheet after an image forming process in the image forming apparatus main body is ejected from a back face side to a front face side in the image forming apparatus main body to allow takeout the recording sheet from the front face side in the image forming apparatus main body,
the cover main body is a front cover constituting at least a part of a front face wall as the vertical face wall of the image forming apparatus main body and turning to the front face side of the image forming apparatus main body.

7. The image forming apparatus according to claim 6, wherein the internal unit includes:
a process unit arranged near the top face wall at the back face side in the image forming apparatus main body to convey the recording sheet to the back face side and to perform the image forming process; and
a developer cartridge unit arranged near the top face wall at the front face side in the image forming apparatus main body to replenish the process unit with a developer,
the developer cartridge unit is configured to be drawable separately from the process unit,
the process unit is configured to be drawable unitedly with the developer cartridge unit along a rail arranged at a side face side of the image forming apparatus main body so that working approach to a unit side face side is allowed.
